(19) United States
(12) Patent Application Publication
(10) Pub. No.: US 2004/0062388 A1
(43) Pub. Date: Apr. 1, 2004

(54) Audio handheld device

(76) Inventors: Donald Lewis MacDonald, Hertfordshire (GB); Peter Leighton Smith, Buckinghamshire (GB)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/451,388

(22) PCT Filed: Dec. 14, 2001
(86) PCT No.: PCT/IB01/02570

(30) Foreign Application Priority Data
Dec. 21, 2000 (GB) 0031352.8

(51) Int. Cl. H04M 1/00; H04M 9/00

(52) U.S. Cl. 379/433.03; 379/433.01

(57) ABSTRACT

An audio handset comprises a body (10) with an earphone (11) and a microphone (12). The microphone (12) has two ports on opposite faces (one of which, A, is seen in FIG. 1) and is mounted on the body (10) by hinge arms (14) to be displaceable, in use, between open and closed positions. In the open position, both ports are available to receive and respond to audible sound and the microphone functions in a noise-cancelling differential mode. In the closed position, one of the ports (A) bears against a sealing face (15) of the body rendering that port unresponsive to audible sound, and the microphone functions in a single port pressure mode.

This invention relates to an audio handheld device.

An audio handheld device, also referred to as an audio handset, is designed to transmit and receive electrical audio frequency band signals and convert them from/to audible sound. A typical handset comprises a body provided with an earphone at one end and a microphone at the opposite end. The body may contain electrical circuitry facilitating operation of the handset and/or be fitted with an electrical switch for external equipment control.

In a conventional handset, the earphone and microphone are fixed relative to the body. The microphone is usually of the single-port pressure mode type which is non noise-cancelling. Alternatively, the microphone may be of the dual-port differential mode type. In this case, the microphone has the capability to reduce the effects of far field audio noise, unlike the pressure mode type. Examples of differential microphones for reducing background noise in telephony are shown in GB-A-2200814 and U.S. Pat. No. 5,682,418.

It is an aim of the invention to provide the user of an audio handset with the choice of adapting the device, in a simple manner, for operation in a noisy or quieter environment.

According to the invention there is provided an audio handheld device comprising a body supporting an earphone and a microphone, wherein the microphone is selectively operable in either a pressure mode or in a noise-cancelling differential mode. Preferably the microphone has two ports and is displaceable, e.g. pivotally with respect to the body, between an open position in which both ports are available to receive and respond to audible sound and in which the microphone operates in said noise-cancelling differential mode and a closed position in which only one of the ports is so available and in which the microphone operates in said pressure mode.

A preferred embodiment of the invention will now be described, by way of example only, with reference to the accompanying drawings in which:

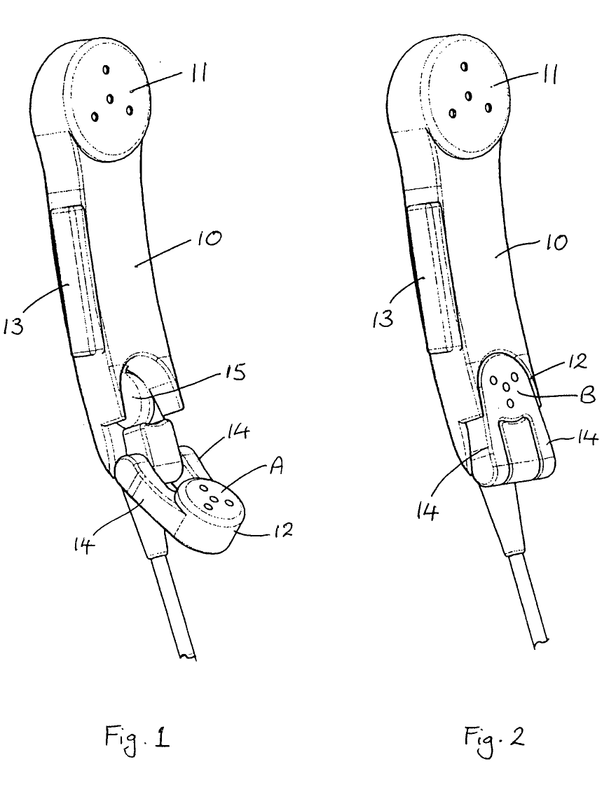

FIG. 1 is a perspective view of an audio handset according to the invention, shown in its open position; and

FIG. 2 is a perspective view of the handset of FIG. 1, shown in its closed position.

Referring to FIGS. 1 and 2, the handset comprises a body 10 provided with an earphone 11 and a microphone 12. A switch 13 is also shown on the body, which may be a “press-to-talk” switch for control of an associated radio transceiver (not shown). The microphone 12 has two ports on opposite faces (port A seen in FIG. 1 and port B seen in FIG. 2) and is mounted on the body 10 by means of hinge arms 14 so that it can be displaced by the user between an open position (shown in FIG. 1) and a closed position (shown in FIG. 2) in which port A bears against a recessed sealing face 15 (FIG. 1) of the body, sealing that port and rendering it unresponsive to audible sound.

In the open position (the position shown in FIG. 1) the handset presents the microphone closer to the mouth and both ports A and B are available to receive and respond to audible sound. Thus, in this open configuration the microphone functions in the dual-port, noise-cancelling differential mode.

In the closed position (the position shown in FIG. 2), the handset has a shorter compact stowable configuration and only one of the ports (port B) is available to receive and respond to audible sound, the other port (port A) being sealed against the sealing face 15 of the body. Thus, in this closed configuration, the microphone functions in the single-port, non noise-cancelling pressure mode.

The described handset offers the user the benefit of choice depending on the scenario or role in which he finds himself; either a compact handset for quick and easy use in a quieter environment (the closed configuration of FIG. 2) or when unfolded (the open configuration of FIG. 1) a handset with noise-cancelling properties for use in a noisier environment.

1. An audio handheld device comprising a body (10) supporting an earphone and a microphone (12), characterised in that the microphone (12) is selectively operable in either a pressure mode (FIG. 2) or in a noise-cancelling differential mode (FIG. 1).

2. A device as claimed in claim 1 wherein said microphone (12) has two ports (A,B) and is displaceable, in use, between an open position (FIG. 1) in which both ports are available to receive and respond to audible sound and in which the microphone (12) operates in said noise-cancelling differential mode and a closed position (FIG. 2) in which only one of the ports (B) is so available and in which the microphone (12) operates in said pressure mode.

3. A device as claimed in claim 2 wherein said microphone (12) is pivotally mounted on said body (10) to be displaceable between said open and closed positions.

4. A device as claimed in claim 3 wherein said body (10) has a sealing face (15) and, in the closed position, the other of said ports (A) bears against the sealing face (15) rendering that port unresponsive to audible sound.
